(19) United States
(12) Patent Application Publication
(10) Pub. No.: US 2026/0330982 A1
(43) Pub. Date: Oct. 22, 2026

(54) METHOD AND SYSTEM OF AIRCRAFT TAXI ROUTE DISPLAY

(71) Applicant: HONEYWELL INTERNATIONAL INC., Charlotte, NC (US)

(72) Inventors: Sabu Mathew, Bangalore (IN); Roshini Mehboob, Bangalore (IN); Thea Feyereisen, Minneapolis, MN (US)

(73) Assignee: HONEYWELL INTERNATIONAL INC., Charlotte, NC (US)

(21) Appl. No.: 19/242,401

(22) Filed: Jun. 18, 2025

(30) Foreign Application Priority Data
Apr. 21, 2025 (IN) 202511038054

(51) Int. Cl. G08G 5/51; G06F 3/0488; G08G 5/21; G08G 5/24

(52) U.S. Cl. CPC G08G 5/51; G06F 3/0488; G08G 5/21; G08G 5/24

(57) ABSTRACT

In one implementation, a method includes displaying an airside map including one or more taxiways or runways and displayed on a display device on an aircraft. After the aircraft receives instructions from a traffic control entity to move the aircraft to an airside location on the airside map, the method includes receiving a location signal indicating a target location is selected on the airside map by using a user input device and without a need to receive a typed indicator of the airside location. The target location is the airside location or is a via location on a taxi route from a current aircraft location and to the airside location. The method includes displaying at least a portion of the taxi route and from a current position of the aircraft to the target location in response to receiving the location signal of the target location.

### CROSS REFERENCE TO RELATED APPLICATION

This application claims priority to India Provisional Patent Application No. 202511038054, filed Apr. 21, 2025, the entire content of which is incorporated by reference herein.

### TECHNICAL FIELD

The subject matter described herein generally relates to aircraft operations, and more particularly relates to aircraft ground navigation at airports.

### BACKGROUND

During aircraft and airport operations, an air traffic control often communicates instructions to move through a taxi route segment, and progressively one segment at a time usually with a clearance control, and with or without mentioning an end destination of the taxi route. The pilot then enters the taxi route or taxi route segment onto a display in the cockpit as a reference while traveling on the taxi route. To perform this, ground navigation some taxi route display systems are often used to display the taxi route entered by the pilot. However, some ground navigation display systems will only permit the entry of an end destination without permitting entry of segments to clearance control points on the taxi route such that the display has limited usefulness. Other ground navigation display systems require too many steps to enter taxi route segments thereby increasing the workload for the pilots. Hence, it is desired to provide an adaptable ground navigation display system that easily maps taxi route segments while reducing pilot workload.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one implementation, a method includes displaying, by at least one processor, an airside map of an airside of an airport including one or more taxiways or one or more runways or both and displayed on a display device on an aircraft. After the aircraft receives instructions from a traffic control entity to move the aircraft to an airside location on the airside map, the method includes receiving, by at least one processor, a location signal indicating a target location is selected on the airside map by using a user input device and without a need to receive a typed indicator of the airside location. The target location is the airside location or is a via location on a taxi route from a current aircraft location and to the airside location. The target location is available to be: (1) an end destination of the taxi route on the airside map that includes taxiway locations, runway locations, or both, (2) a clearance location along the taxi route on the airside map, and the aircraft is to hold until clearance is provided to the aircraft, and (3) an intermediate location on the airside map that is an end of a segment along the taxi route. The method includes displaying at least a portion of the taxi route and from a current position of the aircraft to the target location in response to receiving the location signal of the target location.

In another implementation, a system includes memory, and processor circuitry forming at least one processor communicatively coupled to the memory and being arranged to operate by: displaying an airside map of an airside of an airport including one or more taxiways or one or more runways or both and displayed on a display device on an aircraft, and after the aircraft receives instructions from a traffic control entity to move the aircraft to an airside location on the airside map, receiving a one-touch or one click location signal indicating a target location is selected on the airside map by using a user input device and without a need to receive a typed indicator of the airside location. The target location is the airside location or is a via location on a taxi route from a current aircraft location and to the airside location. The target location is available to be: (1) an end destination of the taxi route on the airside map that includes taxiway locations, runway locations, or both, (2) a clearance location along the taxi route on the airside map where the aircraft is to hold until clearance is provided to the aircraft, and (3) an intermediate location on the airside map that is an end of a segment along the taxi route. The processor then operates by displaying at least a portion of the taxi route and from a start position of the aircraft to the target location in response to receiving the one-touch or the one click location signal of the target location.

In yet another implementation, a non-transitory computer-readable medium includes instructions thereon that when executed by a computing device, cause the computing device to operate by: displaying, by at least one processor, an airside map of an airside of an airport including one or more taxiways or one or more runways or both and displayed on a display device on an aircraft, and after the aircraft receives instructions from a traffic control entity to move the aircraft to an airside location on the airside map, receiving, by at least one processor, a location signal indicating a target location is selected on the airside map by using a user input device and without a need to receive a typed or transcribed indicator of the airside location received from a pilot on the aircraft. The target location is the airside location or is a via location on a taxi route from a current aircraft location and to the airside location. The target location is available to be: (1) an end destination of the taxi route on the airside map that includes taxiway locations, runway locations, or both, (2) a clearance location along the taxi route on the airside map where the aircraft is to hold until clearance is provided to the aircraft, and (3) an intermediate location on the airside map that is an end of a segment along the taxi route. The instructions cause the computing device to operate by displaying at least a portion of the taxi route and from a start position of the aircraft to the target location in response to receiving the location signal of the target location.

Furthermore, other desirable features and characteristics of the disclosed implementations will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 is a schematic diagram of an example aircraft system according to at least one of the implementations disclosed herein;

FIG. 2 is a schematic diagram of an example ground navigation display system according to at least one of the implementations disclosed herein;

FIG. 2A is a schematic diagram of an example taxiway on an airside according to at least one of the implementations disclosed herein;

FIG. 3 is a flow chart of an example method of displaying a segment of a taxi route with a single action according to at least one of the implementations disclosed herein;

FIG. 4 is a schematic diagram of an airside showing an activation view to activate a taxi data entry mode according to at least one of the implementations disclosed herein;

FIG. 5 is a schematic diagram of an airside showing operation of a taxi data entry mode according to at least one of the implementations disclosed herein;

FIG. 6 is a schematic diagram of the airside of FIG. 5 showing another operation of the taxi data entry mode according to at least one of the implementations disclosed herein;

FIG. 7 is a schematic diagram of the airside of FIG. 5 showing yet another operation of the taxi data entry mode according to at least one of the implementations disclosed herein;

FIG. 8 is a flow chart of an example method of displaying multiple candidate taxi routes during a taxi data entry mode according to at least one of the implementations disclosed herein;

FIG. 9 is a schematic diagram of an airside showing operation of a taxi data entry mode with multiple candidate taxi routes according to at least one of the implementations disclosed herein;

FIG. 10 is a schematic diagram of the airside of FIG. 9 showing another operation of the taxi data entry mode with multiple candidate taxi routes according to at least one of the implementations disclosed herein;

FIG. 11 is a flow chart of an example method of tracing taxi routes onto an airside map display during a taxi data entry mode according to at least one of the implementations disclosed herein;

FIG. 12 is a schematic diagram of an airside showing operation of a taxi data entry mode including taxi route tracing according to at least one of the implementations disclosed herein; and

FIG. 13 is a schematic diagram of the airside of FIG. 12 showing anther operation of a taxi data entry mode including taxi route tracing according to at least one of the implementations disclosed herein.

### DETAILED DESCRIPTION

The following detailed description is merely on example and is not intended to limit the subject matter of the application and uses thereof. Furthermore, there is no intention to be bound by any expressed or implied theory presented in the preceding technical field, background, brief summary, brief description of drawings, or the following detailed description.

The disclosed method and system provides increased flexibility for displaying taxi route segments that results in a reduced workload for a pilot to display the taxi routes. This is accomplished by having a prestored database of airside taxi route segments for many different taxi routes available on an airside of an airport. Also, airside maps are provided for display in an aircraft cockpit and with graphical user interfaces, such as with touchscreens as one example, where a pilot is able to receive a final airside destination from an air traffic control, and then place that destination, or a portion or segment of a taxi route along a pathway to that destination, on the airside map with a single touch or click as one example. By other alternatives, a desired portion of the taxi route may be placed on the airside map by having the pilot trace a path shown on the airside map, or multiple alternative candidate taxi route segments may be simultaneously displayed on the airside map, and the pilot can select one of the candidate segments. The desired and displayed target destination or location at the end of a segment (or portion) of the taxi route can be (1) an end destination of the taxi route and that includes taxiway locations, runway locations, or both, (2) a clearance location or via along the taxi route on the airside map where the aircraft is to hold until clearance is provided to the aircraft, and/or (3) any other intermediate location or via on the airside map that is an end of a desired segment along the taxi route and that may or may not be provided by the air traffic control (ATC).

It should be noted herein, the area of an airport where aircraft can move on the ground is referred to as the airside of the airport, where the airside may include a movement area including taxiways and runways that is often controlled by an airport tower and/or an ATC, and a non-movement area including an apron (or ramp or tarmac) where gates to airport terminals or hangars are located, and an aircraft may be permitted to move without airport tower and/or ATC instructions. Thus, an airside map can include the airside movement map (herein referred to as AMM) and/or a map of the non-movement area of the airside. Note that AMM as used herein does not specifically refer to an airside moving map (where a perspective view in a 3D image display in a cockpit moves) although the AMM may be or include a moving map.

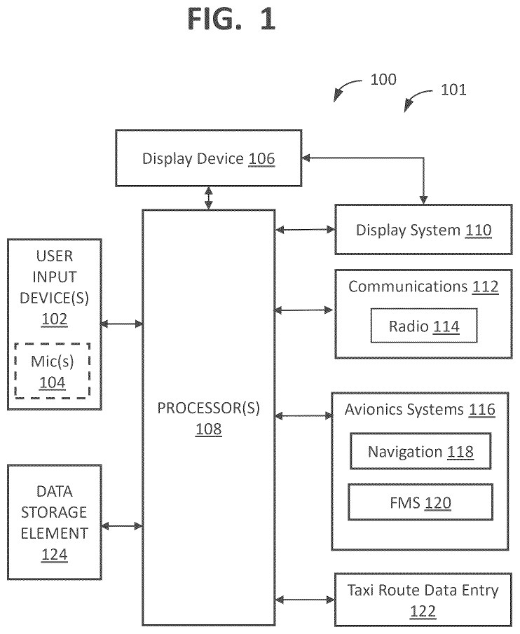

Referring to FIG. 1, an example system 100 may be used by a vehicle, such as an aircraft 101. In an example implementation, the system 100 is at least partially on an aircraft and includes, without limitation, one or more user input devices 102 that may have one or more microphones 104, a display device 106, one or more processors 108, a display system 110, a communications system 112 with a radio 114, one or more other avionics systems 116 with at least a navigation system 118, a flight management system (FMS) 120, and other avionics systems, a taxi route data entry (or taxi route display) unit 122, and data storage element 124.

In example implementations, the display device 106 is an electronic display capable of graphically displaying flight information or other data associated with operation of the aircraft under control of the display system 110 and/or processor 108. In this example, the display device 106 is coupled to the display system 110 and the processor 108, and the processor 108 and the display system 110 are cooperatively configured to display, render, or otherwise convey one or more graphical representations or images associated with operation of the aircraft on the display device 106, and particularly at least an airside map. The airside map shows at least one taxi route displayed by receiving inputs from a user or pilot on one or more of the user input devices 102 so that a pilot can quickly and efficiently show taxi route segments on the airside map and according to instructions received by an air traffic control (ATC) as one example. The user input device 102 is coupled to the processor(s) 108 and may or may not be considered entirely or partially part of display device 106. The user input device 102 and the processor 108 are cooperatively configured to allow a user (e.g., a pilot) to interact with the display device 106 and/or other elements of the system 100, as described in greater detail below. By one form, the display device 106 is or has an interactive graphical user interface (GUI), and may include or be communicatively coupled to, the user input device 102. Depending on the implementation, the user input device(s) 102 may be a keypad or keyboard (whether physical or virtual), touchpad, mouse, touch panel (or touchscreen), joystick, knob, line select key and/or another suitable device adapted to receive input from a user. In some example implementations, the user input device 102 includes an audio input device, such as the microphone 104, audio transducer, audio sensor, or the like, which is adapted to allow a user to provide audio input to the system 100 in a “hands free” manner using speech recognition.

The processor 108 is at least one processor formed by processor circuitry and includes the hardware, software, and/or firmware components configured to operate any of the units described herein, to facilitate communications and/or interaction between the elements of the system 100, and to perform additional tasks and/or functions to support operation of the system 100, as described in greater detail below. Depending on the implementation, the processor 108 may be a general purpose processor such as a central processing unit (CPU), a content addressable memory, a digital signal processor, an application specific integrated circuit, a field programmable gate array, any suitable programmable logic device, discrete gate or transistor logic, processing core(s), discrete hardware components, or any combination thereof, arranged to perform the functions described herein. The processor 108 may also be implemented as a combination of computing devices, e.g., a plurality of processing cores, a combination of a digital signal processor and a microprocessor, a plurality of microprocessors, one or more microprocessors in conjunction with a digital signal processor core, a System on a Chip (SoC), a graphical processing unit (GPU), an image signal processor (ISP), or any other such configuration or combination. In practice, the processor 108 includes processing logic that may be configured to perform the functions, techniques, and processing tasks associated with the operation of the system 100, as described in greater detail below. Furthermore, the steps of a method or algorithm described in connection with the implementations disclosed herein may be embodied directly in hardware, in firmware, in a software module (or unit) executed by the processor 108, or in any practical combination thereof. For example, in one or more implementations, the processor 108 includes or otherwise accesses a data storage element (or memory), which may be realized as any sort of non-transitory short or long term storage media capable of storing programming instructions for execution by the processor 108. The code or other computer-executable programming instructions, when read and executed by the processor 108 (or computing device), cause the processor 108 to support or otherwise perform certain tasks, operations, functions, and/or processes described herein.

The display system 110 is the hardware, software, and/or firmware components configured to control the display and/or rendering of the airside map described herein, one or more other navigational maps, and/or other displays pertaining to operation of the aircraft and/or onboard systems 112, 114, 116, 118, 120, and 122 on the display device 106. In this regard, the display system 110 may access or include one or more databases suitably configured to support operations of the display system 110, such as, for example, a terrain database, an obstacle database, a navigational database, a geopolitical database, a terminal airspace database, a special use airspace database, or other information for rendering and/or displaying navigational maps and/or other content on the display device 106.

In the illustrated implementation, the system 100 includes a data storage element 124, which may hold a database of taxi route data used to display the taxi routes as described below and other data related to taxi routes. This may hold any airside map data and ground navigation data of at least one airside of one specific airport. Depending on the implementation, the data storage element 124 may be physically realized using RAM memory, ROM memory, flash memory, cache, registers, a hard disk, or another suitable data storage medium known in the art or any suitable combination thereof.

In the present example, the processor 108 is coupled to the navigation system 118, which is configured to provide real-time navigational data and/or information regarding operation of the aircraft. The navigation system 118 may be realized as a global positioning system (GPS), inertial reference system (IRS), or a radio-based navigation system (e.g., VHF omni-directional radio range (VOR) or long range aid to navigation (LORAN)), and may include one or more navigational radios or other sensors suitably configured to support operation of the navigation system 118, as will be appreciated in the art. The navigation system 118 is capable of obtaining and/or determining the instantaneous position of the aircraft, that is, the current (or instantaneous) location of the aircraft (e.g., the current latitude and longitude) and the current (or instantaneous) altitude or above ground level for the aircraft. The navigation system 118 is also capable of obtaining or otherwise determining the heading of the aircraft. In the illustrated implementation, the processor 108 is also coupled to the communications system 112, which is configured to support communications to and/or from the aircraft. For example, the communications system 112 may support communications between the aircraft and air traffic control or another suitable command center or ground location. Thus, the communications system 112 may be realized using a radio communication system or device (or unit) 112 with radio 114 and/or another suitable datalink system. The radio 114 may have speakers or headphone connections to emit audio messages from an aircraft or airside broadcasting entity (or traffic control entity). The communications system(s) 112 is, has, or communicates with the avionics systems 120, 116, 118, 122 capable of receiving clearance or other types of communications from other external sources, such as, for example, other aircraft, an air traffic controller, or the like. Depending on the implementation, the communications system(s) 112 may include one or more of a very high frequency (VHF) radio communications system, a controller-pilot data link communications (CPDLC) system, an aeronautical operational control (AOC) communications system, an aircraft communications addressing and reporting system (ACARS), and/or the like.

In example implementations, the processor 108 is also coupled to the FMS 120, which is coupled to the navigation system 118, the communications system 112, the taxi route data entry unit 122, and one or more additional avionics systems 116 to support navigation, flight planning, and other aircraft control functions, as well as to provide real-time data and/or information regarding the operational status of the aircraft to the processor 108. The system 100 and/or aircraft 101 may include numerous avionics systems 116 for obtaining and/or providing real-time flight-related or taxiing-related information that may be displayed on the display device 106 or otherwise provided to a user (e.g., a pilot). For example, practical implementations of the system 100 and/or aircraft will likely include one or more of the following avionics systems suitably configured to support operation of the aircraft: a weather system, an air traffic management system, a radar system, a traffic avoidance system, an autopilot system, an auto-thrust system, a flight control system, hydraulics systems, pneumatics systems, environmental systems, electrical systems, engine systems, trim systems, lighting systems, crew alerting systems, electronic checklist systems, an electronic flight bag (EFB) and/or another suitable avionics system. This data may be used to set ground navigation procedures when relevant, such as an estimated time of arrival (ETA) or estimated time of takeoff (ETT) at a particular airport runway. The FMS 120 also may provide avionics display pages to be shown on the aircraft and that provide a moving map of the airport airside.

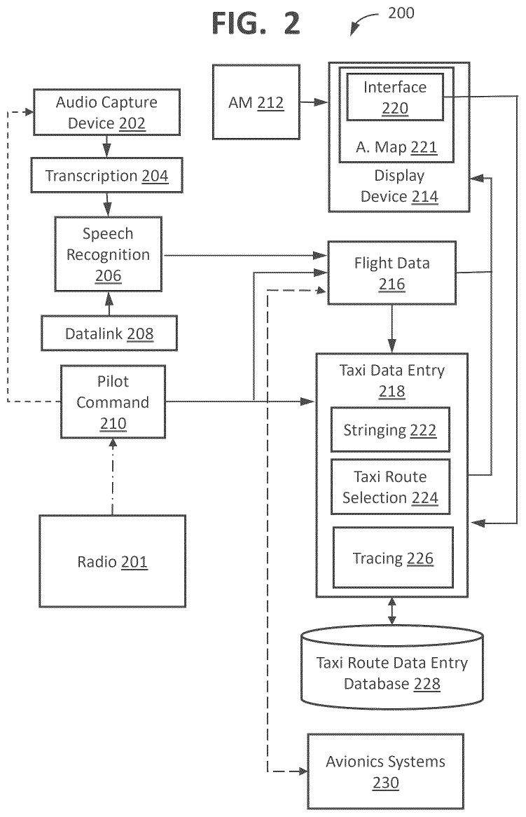

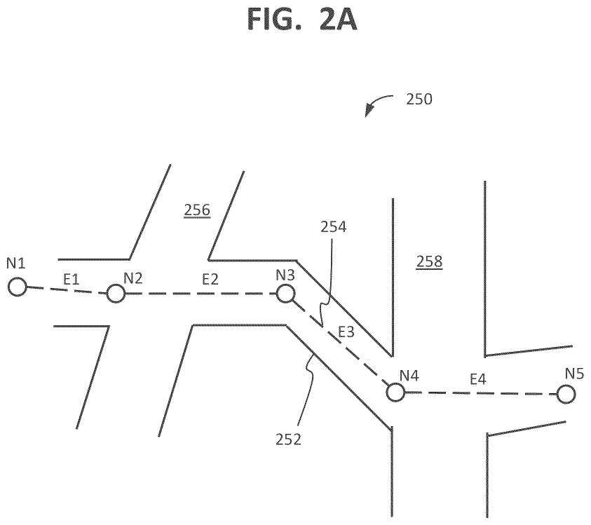

The system 100 also may have the taxi route data entry (or display) unit 122 to manage the display of taxi routes or segments of the taxi routes while receiving updates and entries of route additions from pilots. The taxi route data entry unit 122 may be operated by processor 108 and may be communicatively coupled to the other units of system 100 as desired. The details of the taxi route data entry unit 122 are provided on FIG. 2.

It should be understood that FIG. 1 is a simplified representation of the system 100 for purposes of explanation and ease of description, and FIG. 1 is not intended to limit the application or scope of the subject matter described herein in any way. It should be appreciated that any of the systems, units, and devices of system 100 may be entirely onboard the aircraft or partially onboard and remote from the aircraft. By one form, at least the display device 106 is entirely onboard. Those parts of systems, modules, and units of system 100 external to the aircraft may be communicatively coupled to the remaining elements or parts of the system 100 on the aircraft (e.g., via a data link and/or communications system 112). Similarly, in some implementations, the data storage element 124 may be located external to the aircraft and communicatively coupled to the processor 108 via a data link and/or communications system 112. Furthermore, practical implementations of the system 100 and/or aircraft will include numerous other devices and components for providing additional functions and features, as will be appreciated in the art. In this regard, it will be appreciated that although FIG. 1 shows a single display device 106, in practice, additional display devices may be present onboard the aircraft. Additionally, it should be noted that in other implementations, features and/or functionality of processor 108 described herein can be implemented by or otherwise integrated with the features and/or functionality provided by the FMS 120. In other words, some implementations may integrate the processor 108 with the FMS 120. In yet other implementations, various aspects of the subject matter described herein may be implemented by or at an electronic flight bag (EFB) or similar mobile electronic device that is communicatively coupled to the processor 108 and/or the FMS 120 (or has the processor 108). Thus, the display device 106 may be a mobile device that displays an interactive airside map as described herein at least while the display device 106 is aboard the aircraft.

Referring to FIG. 2, an example taxi route data entry unit (or taxi route display unit) 200 is the same as the taxi route data entry unit 122. The taxi route data entry unit 200 may have a radio 201, same as radio 114, with speakers or headphone connections as well as a datalink unit 208 to announce ground navigation (GN) messages from an airside broadcast (or traffic control) entity such as the aircraft traffic control (ATC) or other ground control (GC). Such messages may be ground navigation messages including a final ground or taxi route destination alone, or one or more clearances (or clear control points) that are at an end of a segment on the taxi route to the final destination. A clearance or clear control point is a location on the airside where the aircraft is to stop and hold until given clearance to proceed. Otherwise, the messages may include any combination of both a final destination and segments (or clearances) on a taxi route to the final destination.

The instructions or commands from the GN messages can be converted into a taxi route display in a number of ways. First, the audible messages from the radio may be heard from a pilot, who then directly uses a user interface 220 to show the airside destinations from the messages on am airside map 221 being displayed on a display device 214. An airside map unit 212 manages the rendering of the airside map 221 such as scale, changing map motion or perspective when provided, features, and so forth. The airside map unit 212 also may provide the layout of the airside including the labels for each taxiway, runway, and so forth, as well as taxiway operations used for a particular airport, the status or availability of the taxiways, taxiways with particular purposes such as with rapid exit taxiways, and so forth. The airside map unit 212 may factor airport operation data that may be obtained from a number of sources provided by the airport itself or other entities.

Optionally, the GN messages may be received electronically over a datalink or the audible message from the radio 201 may be picked up by microphones of an audio capture device 202, as with user input device 102, and then converted into a semantic electronic message by using a transcription unit 204 and a speech recognition unit 206. The message from the datalink unit 210 also may be provided to the speech recognition unit 206 to provide ground navigation instructions to a flight data unit 216. The flight data unit 216 may hold the flight plans and ground navigation plans to be implemented, which can then be automatically displayed on the airside map when provided.

For the method and system here, however, the reduction in workload and display of taxi route segments relates to the direct entry of the ground navigation plan or target taxi route provided from the pilot instead. Thus, a taxi data entry unit 218 has any one or a combination of a stringing unit 222 (also referred to as a one action (or one click or one touch) unit herein), a taxi route selection unit 224, and a tracing unit 226. The stringing unit 222 provides data to render a taxi route one segment at a time where a pilot selects an end of each segment by a single click or single touch on the graphical user interface 220 of the display device 214. The taxi route selection unit 224 provides data to render one taxi route segment selected by a pilot on the graphical user interface 220 among multiple alternative candidate taxi route segments displayed simultaneously on the airside map. Also, the tracing unit 226 provides data to render a taxi route segment traced on the pathways of the airside map by a pilot using the graphical user interface 220 of the display device 214. By one form, the taxi data entry unit 218 only has one of these three taxi route display techniques and associated unit 222, 224, or 226. By other approaches, the taxi data entry unit 218 may have the capability to provide any of the three display techniques, and selection among the three taxi route display techniques may be automatic or may be provided by showing a graphical user interface menu to a user or pilot to make the selection of which of the techniques to use. Many variations are contemplated.

The display technique units 222, 224, and 226 may obtain the start location of the aircraft from the FMS 120 or other avionics system. As explained below, the start location may or may not be the current location of the aircraft. The avionics systems 230 may include the FMS 120 to provide flight plans as well as actually executed parameters, including those in the air on approach and landing, and/or then those used during ground navigation. This may include parameters such as speed, fuel consumed or burnt, time points such as a target time to take-off and an actual time to take-off, as well as multi-function display (MFD) mapping which also may provide a display page or image of taxiway views and aircraft positioning and motion on an airport airside. Otherwise, the FMS 120 also may collect airside data from any other avionics system being used off-board at an airport or on-board an aircraft that monitors the airside aircraft and provides parameters from, or based on, sensors for example, guidance, routing, airside mapping, and so forth to increase situational awareness at the airside. Thus, the FMS 120 itself may provide the current or real-time position, heading, and other real-time aircraft context. The avionics systems 230 may provide the flight plans, aircraft context, and airside taxi route when determined and entered into the systems to the flight data unit 216.

A taxi route or taxi route segment selected or desired by the pilot by using the graphical user interface 220 and the displayed airside map 221 first may be validated before being displayed for a pilot for use by the pilot or avionics systems. This may involve using one or more taxi route data entry databases 228 that has a listing or look-up table of predetermined taxi routes and taxi route segments as well as properties associated with the segments or taxi routes. By one form, this may include all possible taxi routes and taxi route segments on at least one airside at one airport, and ideally for multiple airports such as for all airports in a single country or region, or all airports around the world. This may be limited to airports of a minimum size or air traffic capacity.

To perform the validation, the database 228 may have labels as well as start and end locations for each taxi route and taxi route segment used to form a taxi route on the airside. By one form, the database 228 also has taxi route and segment shapes formed of nodes representing physical end locations on the airside map, and edges between the nodes being the pathways from node to node. The nodes may be limited to pathway intersections or hold (clearance) positions, such as only for runways and taxiways, but otherwise may include any physically distinct features of the pathways of the airside including curves or turns, pavement markings and/or line painting, permanent objects, and so forth. Referring to FIG. 2A for example, an airside 250 has a taxi route 254 on a taxi way 252 and crossing runways 256 and 258. The taxi route 254 may be formed of nodes N1 to N5 and interconnecting edges E1 to E4. Note that the nodes N2 and N4 are at clearance hold positions rather than the center of an intersection, but alternatively could be at the center of the intersection or both locations.

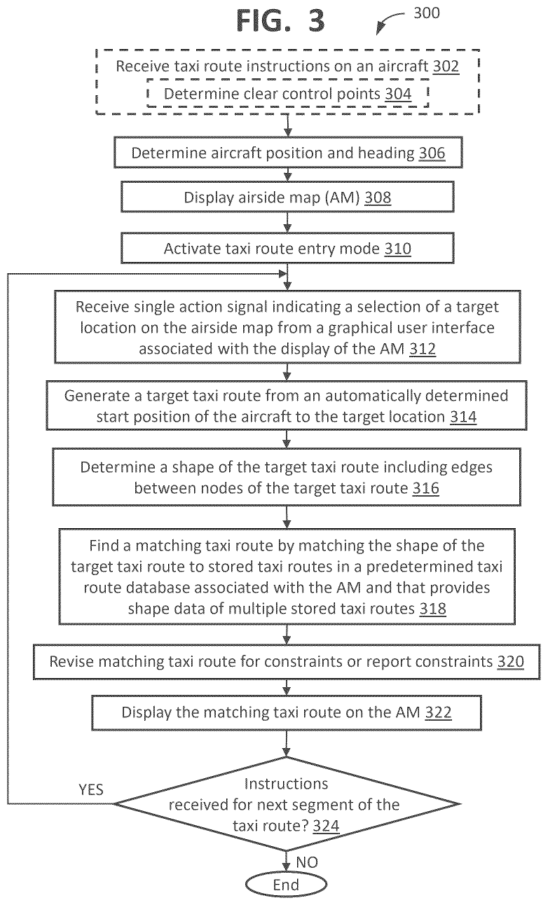

Referring to FIG. 3, a process 300 of displaying taxi route segments in one touch or one click is described in accordance with at least one of the implementations herein. The process 300 includes operations 302 to 322, generally numbered evenly. Systems, devices, modules, units, and images of any of FIGS. 1-2A and 4-13 may be referred to while describing process 300, where relevant.

Process 300 may include “receive taxi route instructions on an aircraft” 302, and as mentioned above, this includes receiving a traffic control entity message that includes instructions to move the aircraft to an airside location which may be an end destination such as a runway, gate, hangar, or apron location, or a clearance control point where the aircraft is to hold until given clearance to proceed along the taxiway, such as at an intersection between a taxiway and a runway. Many different examples may be used. By one form, the end destination of the taxi route may not be provided by the messages until a last message. In this case, the segments may be provided progressively by a sequence of the messages, and the end of a taxi route is not mentioned until a last segment of the full taxi route.

Operation 302 may include “determine clear control points” 304, and this may include receiving instructions of a clearance in the messages, and whether or not the airside location mentioned by the ATC is a clearance location itself. This may be determined by the pilot listening to the messages and/or automatically by transcribing the messages or receiving messages by datalink as mentioned above, and then having the avionics systems determine the clearance locations. Otherwise, the database 228 may list the known clearance locations for individual taxi routes and segments.

Process 300 may include “determine aircraft position and heading” 306, and also as mentioned, this may be monitored and provided by the FMS or other avionics monitoring systems for example.

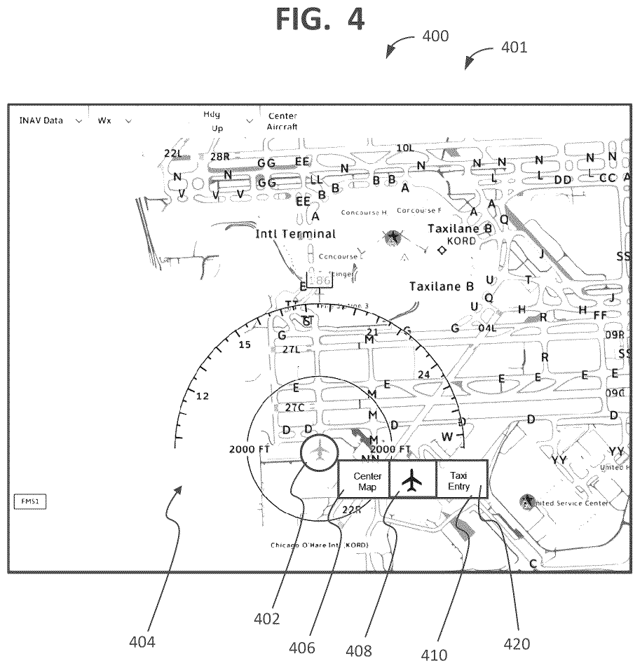

Referring to FIG. 4, process 300 may include “display airside map (AM)” 308, and, by one example, to be displayed on a display in a cockpit of the aircraft. The airside map 400 shows an airside 401 with a number of runways and taxiways labeled by letter and other labels as well as terminal buildings and so forth. The map 400 also shows a current location 402 of the aircraft. The map is being shown on a horizontal situational display 404 on the aircraft.

Process 300 may include “activate taxi route entry mode” 310, where an overlay task menu 420 is provided and that is, or is part of, a graphical user interface as an activator. The menu 420 may include a taxi entry button 410, a center map button 406, and other buttons 408 for various desired functions. Once a user presses the taxi entry button 410, the menu 420 is removed from view and a taxi data entry mode is activated. The menu 420 may have many different configurations.

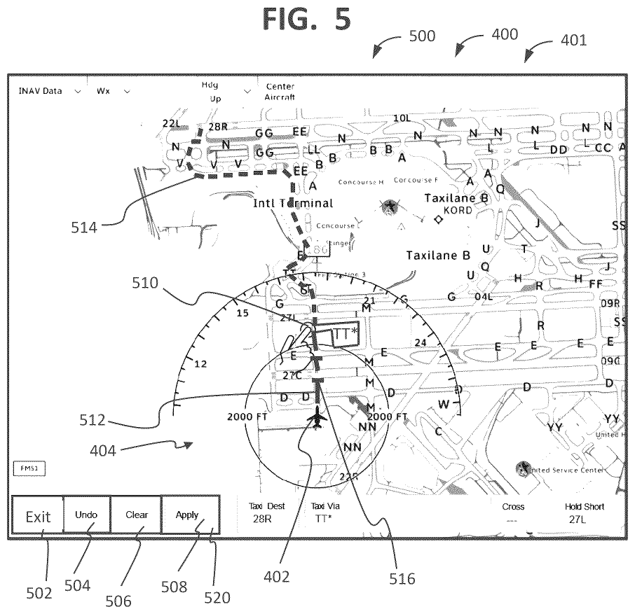

Referring to FIG. 5, process 300 may include “receive single action signal indicating a selection of a target location on the airside map from a graphical user interface associated with the display of the AM” 312. In one example case, the display showing the airside map 400 in a taxi route entry mode 500 is a touch screen so that touching anywhere on the map, or specified areas on the map, may be used to indicate an airside location from the messages. Otherwise, moving a mouse to a desired location and clicking at the location, or using another user input device 102 may work as well. In the case, the user may press a finger (or stylus) or click with a mouse on the screen showing the airside map 400 and at a desired target location 510 that should be an airside location for an end of a segment of a taxi route or that is the end destination of a taxi route. Once activated and received by the stringing unit 222, that selected location on the display may be converted into a target location 510, whether performed by the taxi data entry unit 218 or another unit. The target location 510 then may be provided to the taxi data entry unit 218 if not already in its possession.

Process 300 may include “generate a target taxi route from an automatically determined start position of the aircraft to the target location” 314, and where the taxi data entry unit 218 (or specifically the stringing unit 222) obtains the current aircraft position from the avionics systems as mentioned above, and determines the taxi route or taxi route segment based on the current aircraft position and the target location.

Most often, the start location 402 will be the current or real-time position of the aircraft, but is not necessarily limited to the current aircraft location. The start position may be located at any designated location the aircraft is to travel to in order to start traveling on the taxi route or segment. Thus, this may be a position at an end of an apron and the beginning of the movement area of the airside. Otherwise, the start position may be a gate at a terminal or other designated area on the apron. By other cases, the start position may be a certain distance from the aircraft for a variety of reasons, such as unknown movement of pushback from a tug (or pushback tractor), obstacles that make the taxi route planning near the aircraft unpredictable (such as within 500 feet of the aircraft on the apron) and so forth.

In some cases, generating the taxi route segment may be simple when there is only one possible route from the start location to the target location. When multiple alternative routes can be formed from the start location to the target location and the messages do not indicate which alternative taxi route is to be used, the stringing unit 222 may choose the initial taxi route as the shortest route, the fastest route, or some other simplified criteria. This may be based on predetermined look-up tables in the database 228.

Next, process 300 may include “determine a shape of the target taxi route including edges between nodes of the target taxi route” 316, where the shape of the segment is used to match the target taxi route or segment with one of a set of predetermined permissible taxi routes and segments in database 228. By one form, the target segment is divided into nodes and edges that connect each node as already described above with FIG. 2A. By other options, the matching may be performed by using the start and target positions alone (and this may be practically the same when only two nodes and one edge between the nodes exist for a segment).

Process 300 may include “find a matching taxi route by matching the shape of the target taxi route to stored taxi routes in a predetermined taxi route database associated with the AM and that provides shape data of multiple stored taxi routes” 318. Here, the stringing unit 222 looks up the shape (listed by nodes and edges) in a look-up table on the database 228 that lists the taxi routes and segments by nodes and edges to find a closest match. Other matching may match the physical arrangement of the shapes to one another using matching algorithms (such as with feature matching algorithms for camera images for example). Otherwise, a table of the start and target positions are provided for the look-up instead. If no match is found, the target location is ignored. By one example form, a message is displayed on the display whether over or near the airside map or another display, to inform the pilot to pick a different target location.

Once a match is found, process 300 may include “revise matching taxi route for constraints or report constraints” 320. Thus, the stringing unit 222 then may consider a number of factors such as distance of the segment, time to travel the segment, the number of crossings, the presence of other traffic, taxi wingspan, pavement type, and so forth. The taxi data entry unit 218 then either automatically selects a deemed best segment or taxi route or provides a message to the pilot with instructions on the display or another display that still permits the use of a segment but with some restriction. For example, there may be an instruction to avoid an obstacle (“stay right along taxiway GG”). Many variations may be used depending on the constraint. The determination of the best taxi route or segment may be set by using predetermined rules as to which constraint has priority over others.

Also, the airside map 400 in the taxi route entry mode 500 may have a menu 520 with soft buttons for various functions here including an undo button to undo past actions, a clear button to clear the taxi route depiction from the airside map, an apply button for user confirmation of the input taxi route locations, and an exit button to leave the taxi route entry mode.

Process 300 then may include “display the matching taxi route on the AM” 320, and where the segment 512 of a taxi route 514 is displayed with a distinct visual appearance to indicate it is an approved, validated segment. It should be noted here that clearances 516 along the segment 512 may have been provided along with that target location in a message from the ATC. Otherwise, the clearances (or vias) may have been determined automatically as being associated with the segment or taxi route as saved in the database 228 as known clearances or determined by another avionics system. The approved segment 512 now designated as TT* may be shown in a different color, different line pattern (such as certain dash sizes), line width, line differentiator shapes (such as triangles along the line), and so forth as long as the distinction is easily understood and noticeable to indicate a validated segment or taxi route.

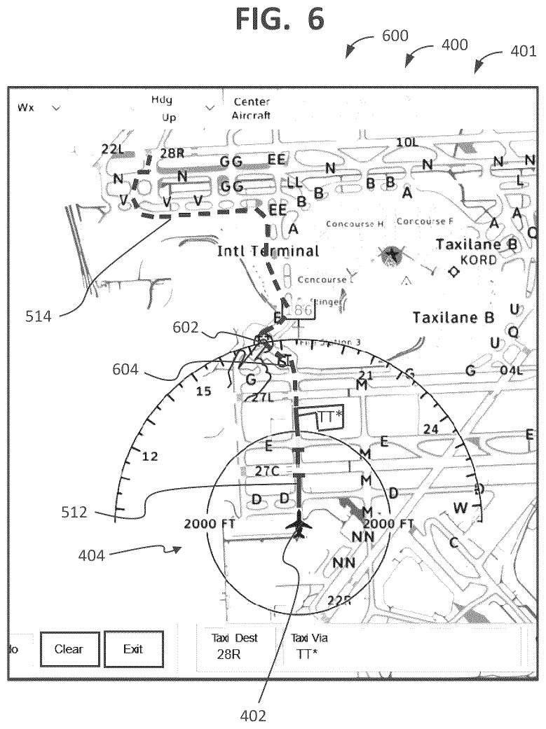

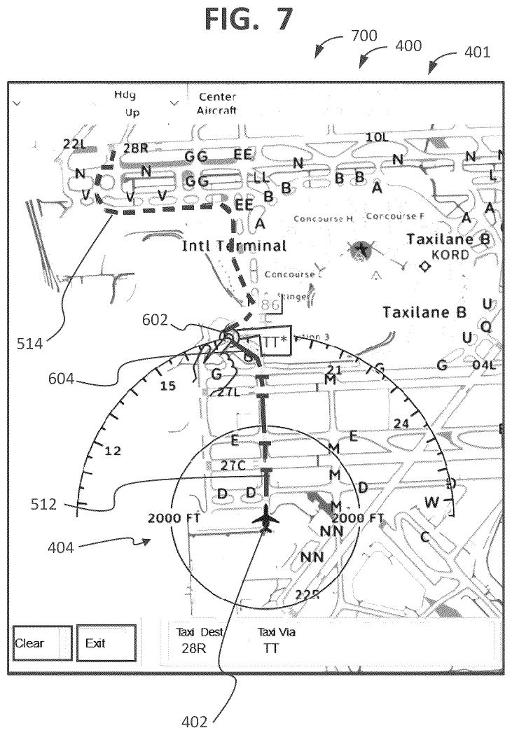

Referring to FIGS. 6-7, process 300 may include the inquiry “instructions received for next segment of the taxi route?” 322, and if not, the process ends. If so, the process loops back to operation 312 where the pilot has touched or clicked on the screen on the airside map 400 at a subsequent time 600 and at a next target location 602 to add another segment 604 to the taxi route 514 at the end of segment 512 (or prior target location 510). The target location 602 is presumably received from another message from the ATC. The process 300 then continues as explained for segment 512 where, as shown on FIG. 7, once the further segment 604 is approved on subsequent annotated airside map 700, the depiction of the segment 604 is changed to indicate it is an approved and validated segment 604, and is now part of the taxi route 514.

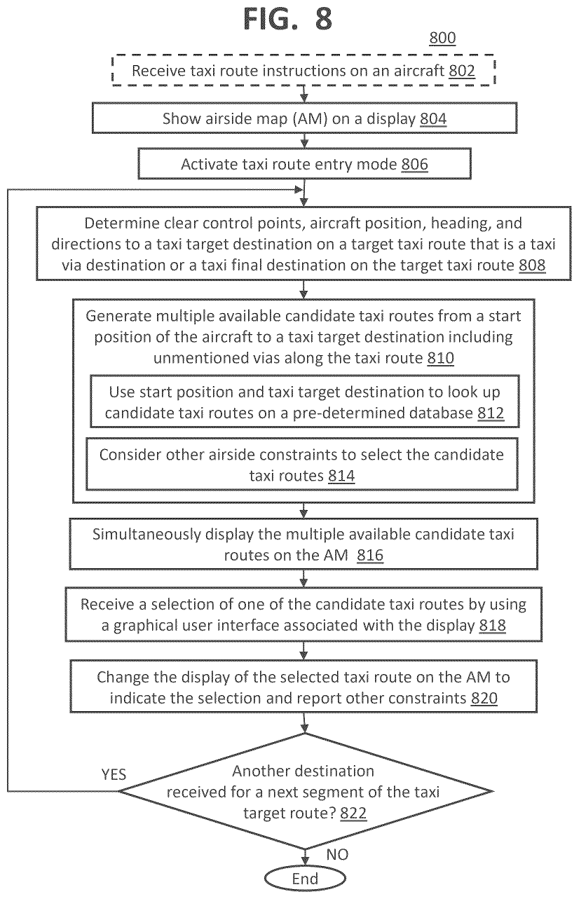

Referring to FIG. 8, a process 800 of displaying taxi route segments by manual selection of one of multiple, alternative, candidate taxi routes is described in accordance with at least one of the implementations herein. The process 800 includes operations 802 to 822, generally numbered evenly. Systems, devices, modules, units, and images of any of FIGS. 1-7 and 9-13 may be referred to while describing process 800, where relevant.

Process 800 may include “receive taxi route instructions on an aircraft” 802, “show airside map (AM)” 804, “activate taxi route entry mode” 806, and “determine clear control points, aircraft position, heading, and directions to a taxi target destination on a target taxi route that is a taxi via destination or a taxi final destination on the target taxi route” 808, all of which are already similarly described above as part of operations 302-310 of process 300.

For this alternative implementation, process 800 may include “generate multiple available candidate taxi routes from a start position of the aircraft to a taxi target destination including unmentioned vias along the taxi route” 810, and performed by the taxi route selection unit 224. The position for the start location (or start position) and the target location are as described above. In this case, however, the pilot is not necessarily required to enter the target location on the airside map. Thus, as described above, the taxi route selection unit 224 may have the ability to receive a single touch or click to set the target location on the airside map. In another approach, however, the taxi route selection unit 224 learns the target location in other operations such as automatically by transcribing an ATC message or using datalink to find an end destination of the taxi route.

Once the start and target locations (or at least end destination) are known, operation 810 may include “use start position and taxi target destination to look up candidate taxi routes on a pre-determined database” 812, and as mentioned above where look-up tables may be provided for each available taxi route and segment of a taxi route. It should be noted that when a final destination is used (or destination with multiple alternative segments), the first segment may have different immediate target locations provided on the airside map. This assumes that subsequent different segments will eventually converge to the final destination.

Operation 810 may include “consider other airside constraints to select the candidate taxi routes” 814, where the look-up table may list, or otherwise be associated with, constraints of each or individual taxi route and segment in the look-up table. The constraints are as mentioned above with operation 320 of process 300. The taxi route selection unit 224 then selects multiple alternative or candidate taxi routes or segments that can be used in light of the constraints.

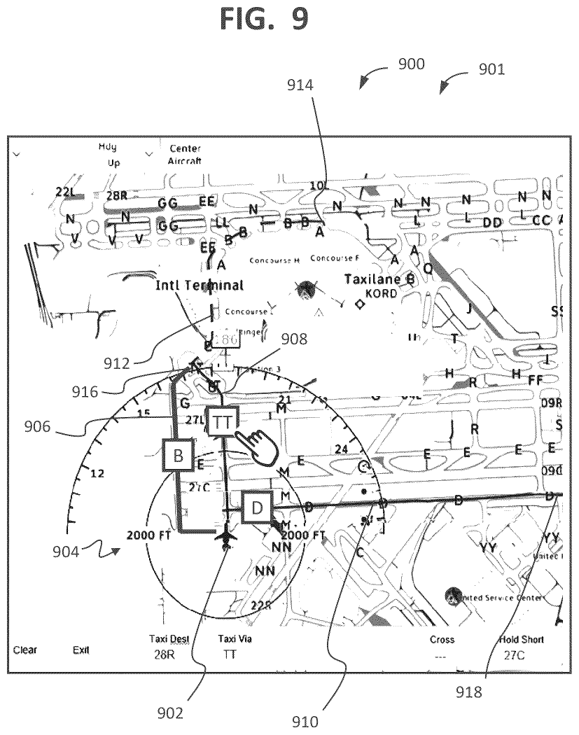

Referring to FIG. 9, process 800 may include “simultaneously display the multiple available candidate taxi routes on the AM” 816, and with the taxi route selection unit 224 providing the data to render the candidate taxi routes. For example, an airside map 900 of an airside 901 shows a start position 902 of an aircraft centered in a horizontal situational display 904 over the airside map 900. Three alternative taxi routes (or segments) are shown including taxiway segment B 906, taxiway segment TT 908, and taxiway segment D 910 that lead to another segment (shown in dashed line) of taxi route 912 with an end destination 914. The alternative taxi routes B, TT, and D each may have a different immediate target location 916 or 918 that will eventually link to a subsequent segment extending toward a common final destination.

Process 800 may include “receive a selection of one of the candidate taxi routes by using a graphical user interface associated with the display” 818. As shown by the hand, the segment TT* is selected by the pilot, and in response, the other two alternative segments 906 and 910 are removed from the airside map 900.

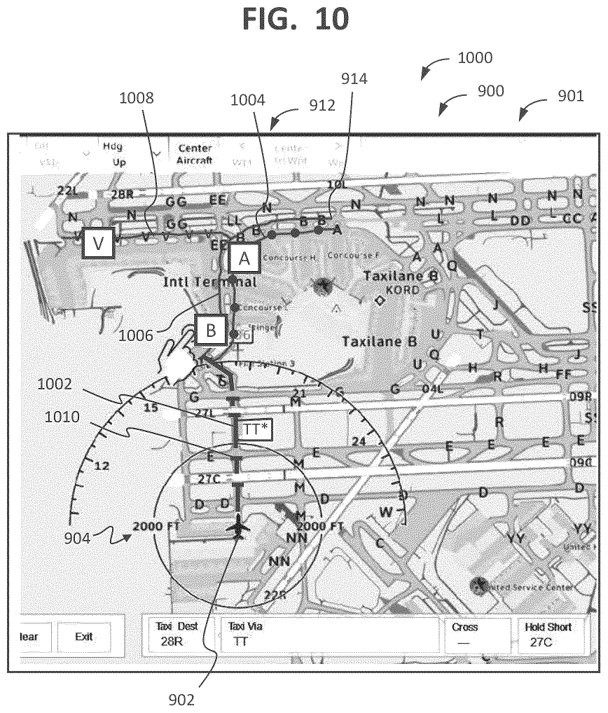

Referring to FIG. 10, process 800 may include “change the display of the selected taxi route on the AM to indicate the selection and report other constraints” 820. A subsequent view 1000 is shown of airside map 900, and where the system changes the appearance of the taxi route segment TT* to be distinct and indicate an approved segment of the taxi route to be used. As mentioned above in process 300, this may include thickening the line or changing the color of the line and so forth. Known clearance locations 1010 are also added to the segment 1002 whether provided by the messages, known from the database 228, or obtained from another system.

Process 800 may include the inquiry “another destination received for a next segment of the target taxi route?” 822, and where if not, the process ends. If so, however, the process loops back to operation 808.

In this case, process 800 proceeds as described and subsequent view 1000 of airside map 900 shows that the taxi route selection unit 224 determines the alternative candidate segments for the next segment of the taxi route 912, now replaced with alternative segment A 1004 shown with large dots, segment B 1006 with only the segment line, and segment V shown with a series of ‘v’s. The pilot is represented here by the hand selecting the segment B. As with the first segment 1002, the unselected segments V and A will be removed from the display, and the appearance of the selected segment B will change as mentioned above for the other selected segments to indicate that segment B is being used.

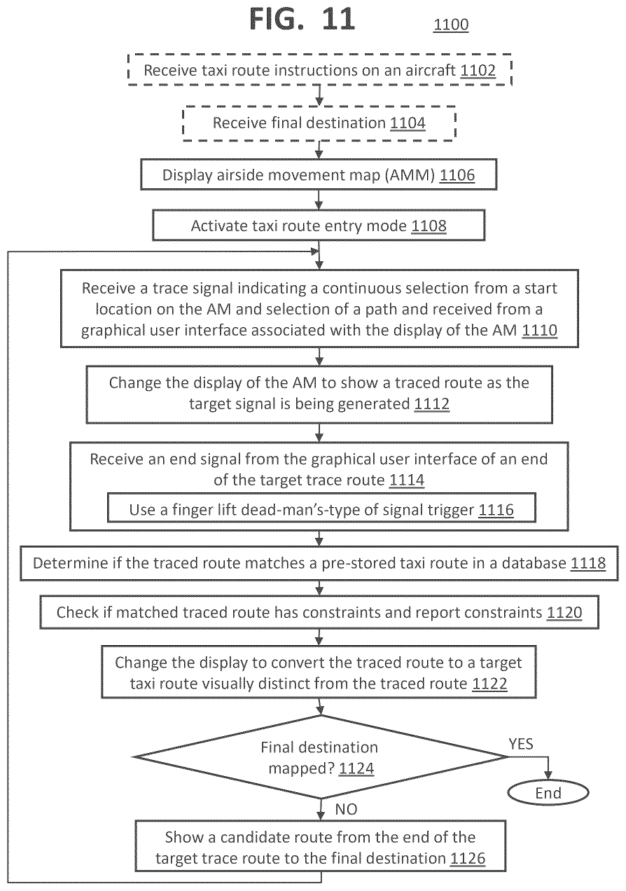

Referring to FIG. 11, a process 1100 of displaying taxi route segments by tracing a taxi route is described in accordance with at least one of the implementations herein. The process 1100 includes operations 1102 to 1126, generally numbered evenly. Systems, devices, modules, units, and images of any of FIGS. 1-10 and 12-13 may be referred to while describing process 1100, where relevant.

Process 1100 may include “receive taxi route instructions on an aircraft” 1102, “show airside map (AM)” 1104, “activate taxi route entry mode” 1106, and “determine clear control points, aircraft position, heading, and directions to a taxi target destination on a target taxi route that is a taxi via destination or a taxi final destination on the target taxi route” 1108, as already described above with processes 300 and 800.

For this alternative implementation, process 1100 may include “receive a trace signal indicating a continuous selection from a start location on the AM and selection of a path and received from a graphical user interface associated with the display of the AM” 1110, and the receiving as well as the other operations below are performed by the tracing unit 226. In this implementation, a user may trace their finger or other instrument such as a stylus on a screen showing the airside map and along a path, such as a taxiway and/or a runway, to select a target segment (or taxi route) to a target location that is at the end of the segment. The target location may be any of the locations described above whether an end of a segment or full taxi route, whether a clearance control point, or whether some other via point.

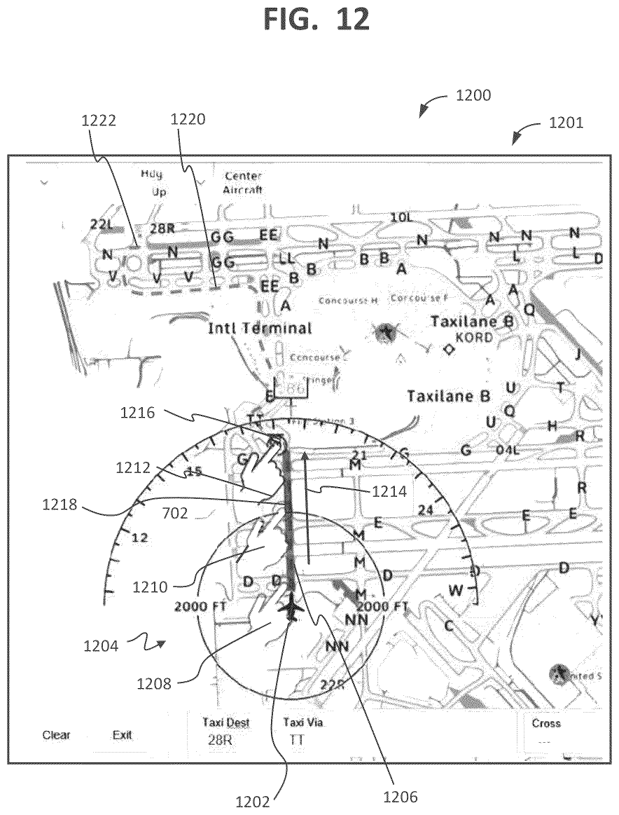

Referring to FIG. 12 for more detail, an airside map 1200 of an airside 1201 of an airport shows an aircraft at a start point 1202 and at the center of a horizontal situational display 1204 that can be shown on a cockpit to a pilot. A pilot may receive an ATC message for a taxi route 1220 from the aircraft start point 1202 with a final destination 1222 at a runway N and a clear control point to stop the aircraft along the taxi route and that is the airside or target location 1216 from the ATC. To display the first segment of the taxi route, the pilot then uses his finger or other stylus or instrument on the touchscreen of the display to then begin to trace a path 1206 from the start point 1202 and upward along the path 1206 as shown by arrow 1214 and as represented, in order, by the hands 1208, 1210, and 1212, until the pilot's finger (or stylus) reaches the target location 1216. It will be understood that the user or pilot may set a different target location whether or not provided by the ATC or other broadcast.

Process 1100 may include “change the display of the AM to show a traced route as the target signal is being generated” 1112, and in one example form, the display of the path 1206 changes as the pilot moves his finger along the path 1206 (or shortly thereafter) to show a traced segment 1218 that is visually distinct from the path 1206 itself and remainder of the airside map 1200. This may be a change in appearance such as a solid line, line thickness, color, line pattern, or any other feature that makes the target segment more distinct from the rest of the airside map as described above with segments of process 300 or 800.

Process 1100 may include “receive an end signal from the graphical user interface of an end of the target trace route” 1114, and by one example form, operation 1114 may include “use a finger lift dead-man's-type of signal trigger” 1116. Thus, in this case, the pilot lifting his finger or another stylus off of the touchscreen that shows the airside map 900 causes an end of segment (or taxi route) signal to be transmitted from the interface 220 and back to the tracing unit 226. The tracing unit 226 then sets the location of the end signal as the end of the traced target location 1216 at the end of traced segment 1218.

Process 1100 may include “determine if the traced route matches a pre-stored taxi route in a database” 1118, and to validate the traced segment 1218 and the target location 1216. For this operation, the tracing unit 226 looks up the traced route 1218 in a look-up table in the database 228. By one form, the matching is already described above based on nodes and edges, or just start and target locations, some combination of both, or some other matching algorithm.

Once a matching segment or taxi route is found, process 1100 may include “check if matched traced route has constraints and report constraints” 1120, and as already described in the constraint operations with process 300 and 800.

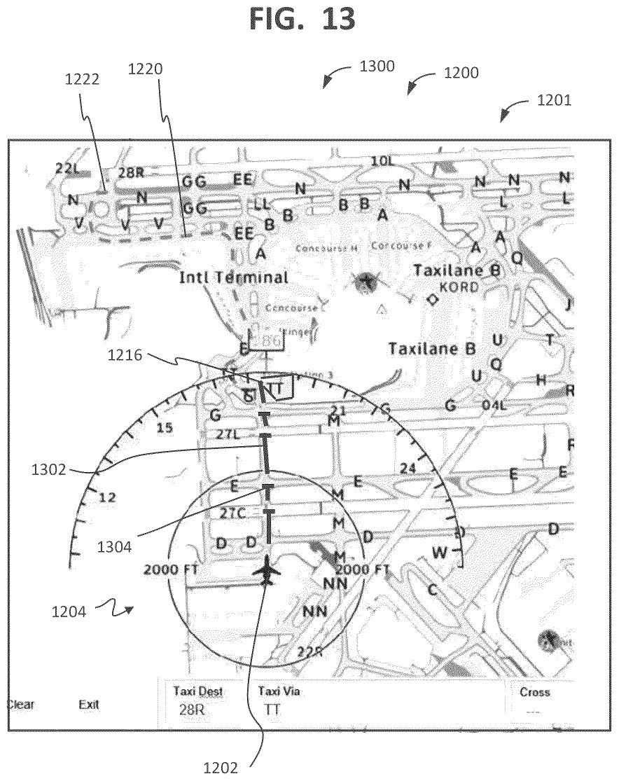

Referring to FIG. 13, process 1100 may include “change the display to convert the traced route to a target taxi route visually distinct from the traced route” 1122, and where another change in appearance is performed to establish a view of the target segment or target taxi route. A subsequent airside map view 1300 of the airside map 1200 shows a validated target segment or target taxi route 1302 extending from the start point 1202 and to the target location 1216. Thus, the target taxi route or segment 1302 may be a different appearance in thickness, color, pattern, and so forth distinct from the traced route 1218. The target segment 1302 also may display clearance control points 1304 obtained from the ATC, the taxi route data entry database 228, the pilot, or another system.

Process 1100 may include the inquiry “final destination mapped?” 1124, and if so, the process ends. If not, the process 1100 loops back to operation 1110 to receive a tracing of a next segment of the taxi route 1220.

Process 1100 also may include “show a candidate route from the end of the target trace route to the final destination” 1126. Thus, the dashed line may show the remaining segments of the taxi route 1220 from the last target location 1216 and to the end destination 1222 here at a runway N. This taxi route to a final destination may be provided when most practical or useful to the pilot.

Those of skill in the art will appreciate that the various illustrative logical blocks, modules, circuits, units, and algorithm operations described in connection with the implementations disclosed herein may be implemented as electronic hardware, firmware, computer software, or combinations thereof. Some of the implementations and implementations are described above in terms of functional and/or logical block components (or modules) and various processing operations. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and operations have been described above generally in terms of their functionality. Whether such functionality is implemented as hardware, firmware, or software depends upon the particular application and design constraints imposed on the overall system. Skilled artisans may implement the described functionality in varying ways for each particular application, but such implementation decisions should not be interpreted as causing a departure from the scope of the present invention. For example, an implementation of a system or a component may employ various integrated circuit components, e.g., memory elements, digital signal processing elements, logic elements, look-up tables, or the like, which may conduct a variety of functions under the control of one or more microprocessors or other control devices. In addition, those skilled in the art will appreciate that implementations described herein are merely exemplary implementations.

The subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can conduct the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an implementation of a system or a component may employ various integrated circuit components, e.g., memory elements, digital signal processing elements, logic elements, look-up tables, or the like, which may conduct a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium,” “processor-readable medium,” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” or “units” in order to particularly emphasize their implementation independence. For example, functionality referred to herein as a module or unit may be implemented wholly, or partially, as a hardware circuit comprising custom VLSI circuits or gate arrays, off-the-shelf semiconductors such as logic chips, transistors, or other discrete components as described above. A module may also be implemented in programmable hardware devices such as field programmable gate arrays, programmable array logic, programmable logic devices, or the like. Modules or units may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process operations must be performed in a temporal or logical order according to such sequence unless it is specifically defined by the language of the claim. The process operations may be interchanged in any order without departing from the scope of the invention as long as such an interchange does not contradict the claim language and is not logically nonsensical.

Furthermore, the foregoing description may refer to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. For example, two elements may be coupled to each other physically, electronically, logically, or in any other manner, through one or more additional elements. Thus, although the drawings may depict one exemplary arrangement of elements directly connected to one another, additional intervening elements, devices, features, or components may be present in an implementation of the depicted subject matter. In addition, certain terminology may also be used herein for the purpose of reference only, and thus are not intended to be limiting.

While at least one example implementation has been presented in the foregoing detailed description of the invention, it should be appreciated that a vast number of variations exist. It should also be appreciated that the exemplary implementation or exemplary implementations are only examples, and are not intended to limit the scope, applicability, or configuration of the invention in any way. Rather, the foregoing detailed description will provide those skilled in the art with a convenient road map for implementing an exemplary implementation of the invention. It being understood that various changes may be made in the function and arrangement of elements described in an exemplary implementation without departing from the scope of the invention as set forth in the appended claims.

What is claimed is:

1. A method, comprising:
displaying, by at least one processor, an airside map of an airside of an airport including one or more taxiways or one or more runways or both and displayed on a display device on an aircraft;
after the aircraft receives instructions from a traffic control entity to move the aircraft to an airside location on the airside map, receiving, by at least one processor, a location signal indicating a target location is selected on the airside map by using a user input device and without a need to receive a typed indicator of the airside location,
wherein the target location is the airside location or is a via location on a taxi route from a current aircraft location and to the airside location, wherein the target location is available to be:
(1) an end destination of the taxi route on the airside map that includes taxiway locations, runway locations, or both,
(2) a clearance location along the taxi route on the airside map wherein the aircraft is to hold until clearance is provided to the aircraft, and
(3) an intermediate location on the airside map that is an end of a segment along the taxi route; and
displaying at least a portion of the taxi route and from a current position of the aircraft to the target location in response to receiving the location signal of the target location.

2. The method of claim 1, wherein the input device is a mouse or a touchscreen on the display device showing the airside map, and wherein the location signal indicates a single click from the mouse or from a single touch on the touch screen, wherein the single click or touch triggers a display of at least the portion of the taxi route to the target location.

3. The method of claim 1, comprising displaying multiple alternative taxi routes on the airside map; and wherein the receiving of the target location by use of the user input device indicates a user selection of one of the multiple alternative taxi routes that extends between a current aircraft position and the target location.

4. The method of claim 1, wherein the receiving of the location signal indicating a target location comprises receiving multiple target locations along the taxi route in a sequence and each adding a subsequent segment to the taxi route from a previously established target location, wherein multiple subsequent segments are each a selection of one segment among multiple available alternative segments extending from the previously established target location and farther along the taxi route that is closer to or at the end destination.

5. The method of claim 1, wherein receiving of the target location by use of the user input device comprises receiving multiple location signals indicating a user continuously tracing a path on the airside map by using the user input device.

6. The method of claim 5, wherein the user input device is a touch screen so that the user can use their finger to trace the path on the airside map.

7. The method of claim 6, comprising converting the path into a visible portion of the taxi route on the airside map when the user tracing the path lifts their finger off of the airside map.

8. The method of claim 1, comprising extending the taxi route on the airside map comprising receiving target locations each of one segment of multiple segments and for one segment at a time in a travel order along the taxi route.

9. The method of claim 8, wherein the multiple segments are added to the taxi route in correspondence to the aircraft moving along the taxi route.

10. A system, comprising:
memory; and
processor circuitry forming at least one processor communicatively coupled to the memory and being arranged to operate by:
displaying an airside map of an airside of an airport including one or more taxiways or one or more runways or both and displayed on a display device on an aircraft,
after the aircraft receives instructions from a traffic control entity to move the aircraft to an airside location on the airside map, receiving a one-touch or one click location signal indicating a target location is selected on the airside map by using a user input device and without a need to receive a typed indicator of the airside location,
wherein the target location is the airside location or is a via location on a taxi route from a current aircraft location and to the airside location, wherein the target location is available to be:
(1) an end destination of the taxi route on the airside map that includes taxiway locations, runway locations, or both,
(2) a clearance location along the taxi route on the airside map wherein the aircraft is to hold until clearance is provided to the aircraft, and
(3) an intermediate location on the airside map that is an end of a segment along the taxi route, and
displaying at least a portion of the taxi route and from a start position of the aircraft to the target location in response to receiving the one-touch or the one click location signal of the target location.

11. The system of claim 10, wherein the at least one processor is arranged to operate by searching to find a match of the portion of the taxi route with a matched taxi route segment of multiple predetermined taxi route segments stored in a database, and displaying the portion of the taxi route if the match is found.

12. The system of claim 10, wherein the searching comprises matching nodes linked by edges between the nodes of the portion of the taxi route to the nodes of the predetermined taxi route segments.

13. The system of claim 10, wherein the searching comprises matching a start location and the target location to start and target locations of each of the multiple predetermined taxi route segments.

14. The system of claim 10, wherein receiving of the target location by use of the user input device comprises receiving multiple location signals indicating a user continuously tracing a path on the airside map by using the user input device, and wherein the searching is performed once an end of the tracing is indicated.

15. The system of claim 14, wherein the portion of the taxi route is displayed with visible hold clearance points along the portion.

16. At least one computer-readable medium comprising instructions thereon that when operated by a computing device, cause the computing device to operate by:
displaying, by at least one processor, an airside map of an airside of an airport including one or more taxiways or one or more runways or both and displayed on a display device on an aircraft;
after the aircraft receives instructions from a traffic control entity to move the aircraft to an airside location on the airside map, receiving, by at least one processor, a location signal indicating a target location is selected on the airside map by using a user input device and without a need to receive a typed or transcribed indicator of the airside location received from a pilot on the aircraft,
wherein the target location is the airside location or is a via location on a taxi route from a current aircraft location and to the airside location, wherein the target location is available to be:
(1) an end destination of the taxi route on the airside map that includes taxiway locations, runway locations, or both,
(2) a clearance location along the taxi route on the airside map wherein the aircraft is to hold until clearance is provided to the aircraft, and
(3) an intermediate location on the airside map that is an end of a segment along the taxi route; and
displaying at least a portion of the taxi route and from a start position of the aircraft to the target location in response to receiving the location signal of the target location.

17. The medium of claim 16, wherein the instructions cause the computing device to operate by automatically determining whether the target location and at least the portion of the taxi route is at a permissible location at the airside; and performing the displaying of the at least the portion of the taxi route if the target location and the portion of the taxi route is determined to be at the permissible location.

18. The medium of claim 17, wherein the determining of the permissible location of the portion of the taxi route comprises considering constraints comprising at least one of: shortest distance to a final airside destination, shortest duration to a final airside destination, a number of runway crossings, a width of runway crossings, a taxi wingspan of the aircraft and clearance for obstacles on the airside, a pavement type of taxi route segments, airport limitations for vehicle-type on pathways, aviation regulation limitations for vehicle-type on pathways.

19. The medium of claim 16, wherein the instructions cause the computing device to operate by automatically providing a taxi route entry mode activator upon display of the airside map.

20. The medium of claim 16, wherein the target location is a via selected by the pilot of the aircraft rather than receiving the via from an air traffic control.
